(19) United States
(12) Patent Application Publication
(10) Pub. No.: US 2025/0119754 A1
(43) Pub. Date: Apr. 10, 2025

(54) SYSTEM AND METHOD FOR MANAGING SPECTRUM MICRO LEASES

(71) Applicant: Nextivity, Inc., San Diego, CA (US)

(72) Inventor: Michiel Petrus Lotter, Poway, CA (US)

(21) Appl. No.: 18/912,478

(22) Filed: Oct. 10, 2024

Related U.S. Application Data
(60) Provisional application No. 63/543,465, filed on Oct. 10, 2023.

(51) Int. Cl. H04W 16/14; H04W 4/24; H04W 48/10; H04W 52/38

(52) U.S. Cl. CPC H04W 16/14; H04W 4/24; H04W 48/10; H04W 52/386

(57) ABSTRACT

A system and method for managing spectrum micro-leases of a portion of a geographic area associated with a micro area network and based on a spectrum lease of a wireless spectrum of a wide area network covering the geographic area. A system includes a processor and a database having an information store. The information store is configured to store an accounting record of all spectrum leases, including micro-leases, the accounting record including a location of the spectrum lease and a description of the border of the geographic area associated with the spectrum lease. The processor is configured to manage one or more micro-leases of the portion of the geographic area, and configured to receive and detect a network ID being used by the wide area network, and which informs the micro area network of the network ID. The micro area network then broadcasts the wide area network ID in addition to the micro network ID, allowing users of the wide area network to access the micro area network.

### CROSS REFERENCE TO RELATED APPLICATION

This application claims the benefit of U.S. Provisional Application No. 63/543,465, filed Oct. 10, 2023, entitled “System and Method for Managing Spectrum Micro Leases”, the disclosure of which is incorporated, in its entirety by this reference.

### BACKGROUND

Wireless spectrum is a valuable and limited resources that typically is controlled by a central authority such as the Federal Communications Commission (FCC). The FCC would typically allocate spectrum to specific parties and allow them to operate wireless systems using the allocated spectrum in specific geographic locations. The definition of the geographic area could be as large as a country or a state, or smaller such as a county. However, typically, spectrum allocations are not made on smaller geographic areas.

Spectrum owners or lease holders may sub-lease their spectrum to third parties in a contract known as a “micro-lease,” and allow third parties to use the spectrum as if they owned or controlled the spectrum. An example is where the spectrum holder leases the spectrum in two different geographical areas to two different parties.

Such lease agreements may result in the inefficient use of the spectrum as the sub-lease holder may not require use of the spectrum across a whole geographical area. For example, an electric utility may lease spectrum from a spectrum holder and use the spectrum to perform automated meter reading. Such an operation does not necessarily require in-building coverage for example.

### SUMMARY

This document discloses a system and method that can keep track of and manage spectrum micro-leases. A spectrum micro-lease is a spectrum lease in a small geographic area, such as inside a building.

In some aspects, a system and method for managing spectrum micro-leases of a portion of a geographic area associated with a micro area network and based on a spectrum lease of a wireless spectrum of a wide area network covering the geographic area are described.

A system includes a processor and a database having an information store. The information store is configured to store an accounting record of all spectrum leases, including micro-leases, the accounting record including a location of the spectrum lease and a description of the border of the geographic area associated with the spectrum lease. The processor is configured to manage one or more micro-leases of the portion of the geographic area, and configured to receive and detect a network ID being used by the wide area network, and which informs the micro area network of the network ID. The micro area network then broadcasts the wide area network ID in addition to the micro network ID, allowing users of the wide area network to access the micro area network

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 illustrates a system and method for defining and managing spectrum micro-leases.

Like reference symbols in the various drawings indicate like elements.

### DETAILED DESCRIPTION

This document describes a system and method to keep track of what is known as “spectrum micro-leases.” A spectrum micro-lease is a spectrum lease in a small geographic area, such as inside a building. Such a system of micro-leases is novel and provides new business models for spectrum owners, building owners, network operators and others.

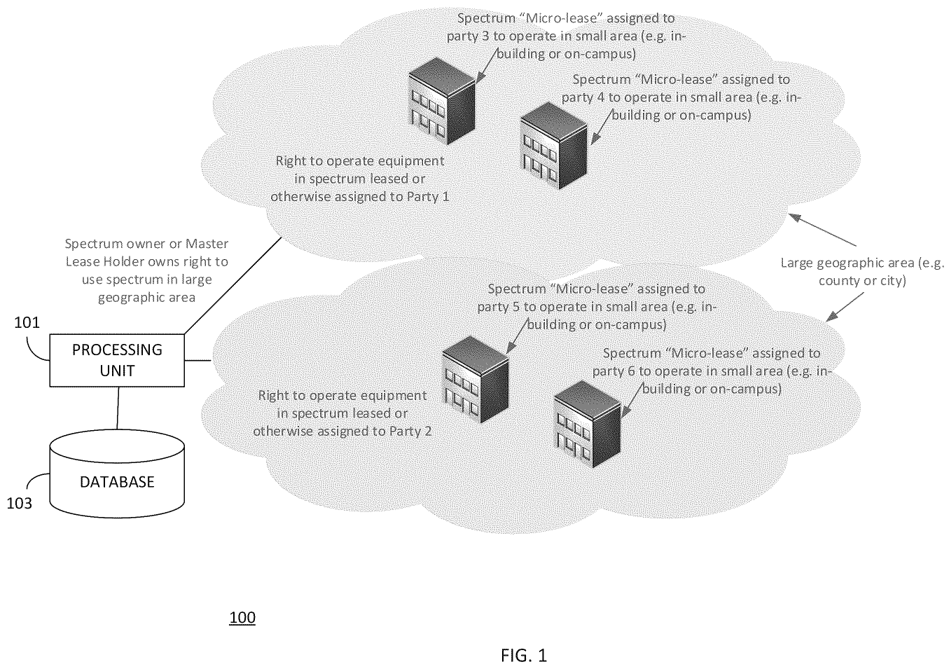

As shown in FIG. 1, many such micro-leases can exist in a geographic area, along with a large area lease. For example, in FIG. 1, Party 1 may operate a network over the whole of the geographic area, whereas Party 3 and Party 4 may operate different networks inside two building only using the same spectrum.

Accordingly, and with reference to FIG. 1, a system 100, which includes a processing unit 101 and a database 103, and method of operating the same, is configured to keep an accounting record of all spectrum leases, including micro-leases, in an information store. The information stored relating to the spectrum lease can include a location of the lease and a size of the lease, or alternatively, a description of the border of the lease area. The border can be geographic, or based on other definable characteristics or attributes, such as by structure (i.e., building, house, etc.) or other characteristics.

The information stored relating to the spectrum lease includes information relating to spectrum sharing such as a list of the network ID's that share spectrum in a specific area. In some implementations, the information stored includes the conditions under which the spectrum is shared. The spectrum lease information details are dynamically updated as networks are turned on and off.

In some implementations of the subject matter described herein, a system to manage the sharing of spectrum between a micro-lease holder and a wide area lease holder includes a processor 101 that is configured to receive and detect a network ID being used by the wide area network, and which informs the micro area network of the network ID and where the micro area network broadcasts the wide area network ID in addition to the micro network ID, allowing users of the wide area network to access the micro area network.

In yet other implementations, a system is provided to manage a transmit power level of the micro network that measures the wide area network level at various points (such as at the edge of the coverage area) and sets the micro network transmit power level to a pre-determined value. The pre-determined value can be set higher, lower or the same as the wide area network. The system can manage the interference between the micro area network and the wide area network outside the micro network coverage area and/or ensure that the micro area network has sufficient dominance over the wide area network in the region of operation.

Although a few embodiments have been described in detail above, other modifications are possible. Other embodiments may be within the scope of the following claims.

1. A system for managing spectrum micro-leases of a portion of a geographic area associated with a micro area network and based on a spectrum lease of a wireless spectrum of a wide area network covering the geographic area, the system comprising:
a processor; and
a database having an information store configured to store an accounting record of all spectrum leases, including micro-leases, the accounting record including a location of the spectrum lease and a description of the border of the geographic area associated with the spectrum lease;
wherein the processor is configured to manage one or more micro-leases of the portion of the geographic area, the processor being configured to receive and detect a network ID being used by the wide area network, and which informs the micro area network of the network ID, and wherein the micro area network broadcasts the wide area network ID in addition to the micro network ID, allowing users of the wide area network to access the micro area network.

2. The system in accordance with claim 1, wherein the processor is further configured to manage a transmit power level of the micro network that measures the wide area network level at various points and sets the micro network transmit power level to a pre-determined value.

3. The system in accordance with claim 1, wherein the micro area network is associated with a building within the geographic area.

4. The system in accordance with claim 1, wherein the micro area network is associated with a plurality of buildings within the geographic area.

5. The system in accordance with claim 2, wherein the pre-determined value of the transmit power level can be set higher, lower or the same as the transmit power level of the wide area network.
